(19) United States
(12) Patent Application Publication
(10) Pub. No.: US 2026/0149380 A1
(43) Pub. Date: May 28, 2026

(54) INTERLEAVED SWITCHING CONVERTER WITH UNBALANCED INDUCTORS AND ASSOCIATED CONTROL CIRCUIT AND METHOD

(71) Applicant: Chengdu Monolithic Power Systems Co., Ltd., Chengdu (CN)

(72) Inventors: Jicheng Wang, Hangzho (CN); Guangzhuo Li, Hangzhou (CN)

(21) Appl. No.: 19/402,160

(22) Filed: Nov. 26, 2025

(30) Foreign Application Priority Data
Nov. 27, 2024 (CN) 202411720002.8

(51) Int. Cl. H02M 3/158

(52) U.S. Cl. CPC H02M 3/1584

(57) ABSTRACT

A control circuit for an interleaved switching converter with a first switching circuit and a second switching circuit. The control circuit has a designating unit. The designating unit selectively designates one of the first switching circuit and the second switching circuits as a master switching circuit and the other switching circuit as a slave switching circuit. The master switching circuit operates with a first ON-time. The slave switching circuit operates with a second ON-time that is different from the first ON-time.

### CROSS-REFERENCE TO RELATED APPLICATIONS

This application claims the benefit of CN application No. 202411720002.8, filed on Nov. 27, 2024, and incorporated herein by reference.

### TECHNICAL FIELD OF THE INVENTION

The present invention generally relates to electronic circuits, and more particularly but not exclusively, to control circuits for interleaved switching converters with unbalanced inductors and associated control methods.

### BACKGROUND OF THE INVENTION

For the scenario of the high power demand, it is often necessary to use an interleaved switching converter including two switching circuits to work in parallel. However, the power distribution is uneven due to the unbalanced energy storage elements, which has a great impact on the heat dissipation, stability and reliability of the interleaved switching converter. Therefore, how to ensure reliable power distribution and safe and effective operation of the interleaved switching converter becomes a challenge.

### SUMMARY OF THE INVENTION

There has been provided, in accordance with an embodiment of the present disclosure, a control circuit for an interleaved switching converter with a first switching circuit and a second switching circuit. The control circuit comprises a first current sense terminal, a first zero crossing sense terminal, a second current sense terminal, a second zero crossing sense terminal, a designating unit, a master switch control unit, a second ON-time generator and a slave switch control unit. The first current sense terminal is configured to receive a first current sense signal representative of a current flowing through a first power switch of the first switching circuit. The first zero crossing sense terminal is configured to receive a first zero crossing detection signal representative of a voltage across the first power switch. The second current sense terminal is configured to receive a second current sense signal representative of a current flowing through a second power switch of the second switching circuit. The second zero crossing sense terminal is configured to receive a second zero crossing detection signal representative of a voltage across the second power switch. The designating unit is configured to selectively designate one of the first switching circuit and the second switching circuit as a master switching circuit and the other as a slave switching circuit. The master switch control unit is configured to control the master switching circuit to operate with a first ON-time. The second ON-time generator is configured to provide a second ON-time based on the first ON-time. The slave switch control unit is configured to control the slave switching circuit to operate with the second ON-time.

There has also been provided, in accordance with an embodiment of the present disclosure, an interleaved switching converter. The interleaved switching converter comprises a first switching circuit with a first inductor and a first power switch, a second switching circuit with a second inductor and a second power switch, and a control circuit. The control circuit comprises a first current sense terminal, a first zero crossing sense terminal, a second current sense terminal, a second zero crossing sense terminal, a designating unit, a master switch control unit, a second ON-time generator and a slave switch control unit. The first current sense terminal is configured to receive a first current sense signal representative of a current flowing through the first power switch. The first zero crossing sense terminal is configured to receive a first zero crossing detection signal representative of a voltage across the first power switch. The second current sense terminal is configured to receive a second current sense signal representative of a current flowing through the second power switch. The second zero crossing sense terminal is configured to receive a second zero crossing detection signal representative of a voltage across the second power switch. The designating unit is configured to selectively designate one of the first switching circuit and the second switching circuit as a master switching circuit and the other switching circuit as a slave switching circuit. The master switch control unit is configured to control the master switching circuit to operate with a first ON-time. The second ON-time generator is configured to provide a second ON-time based on a first ON-time. The slave switch control unit is configured to control the slave switching circuit to operate with the second ON-time.

There has also been provided, in accordance with an embodiment of the present disclosure, a control method for an interleaved converter with a first switching circuit and a second switching circuit. The control method comprises: dynamically designating one of the first switching circuit and the second switching circuit as a master switching circuit and the other switching circuit as a slave switching circuit, providing a second ON-time based on a first ON-time, configuring the master switching circuit to operate with the first ON-time, and configuring the slave switching circuit to operate with the second ON-time.

### BRIEF DESCRIPTION OF DRAWINGS

The present invention can be further understood with reference to the following detailed description and the appended drawings, wherein like elements are provided with like reference numerals.

FIG. 1 shows a schematic diagram of an interleaved switching converter 100 in accordance with an embodiment of the present invention.

FIG. 2 shows working waveforms of a power factor correction circuit operating in different working modes.

FIG. 3 shows working waveforms of a master switching circuit of the interleaved switching converter 100 in accordance with an embodiment of the present invention.

FIG. 4 shows a relationship diagram among a first ON-time, a feedback compensation signal and a peak signal of an input rectified voltage in accordance with an embodiment of the present invention.

FIG. 5 shows working waveforms of an interleaved switching converter 100 with balanced inductors in accordance with an embodiment of the present invention.

FIG. 6 shows working waveforms of an interleaved switching converter with unbalanced inductors.

FIGS. 7a and 7b show a comparison of working waveforms between the interleaved switching converter with balanced inductors and unbalanced inductors in accordance with an embodiment of the present invention.

FIG. 8 shows working waveforms of an interleaved switching converter 100 after introducing a designating unit 104 in accordance with an embodiment of the present invention.

FIG. 9 shows a schematic diagram of an interleaved switching converter 100A in accordance with an embodiment of the present invention.

FIG. 10 shows a flow diagram of a control method 600 for an interleaved switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

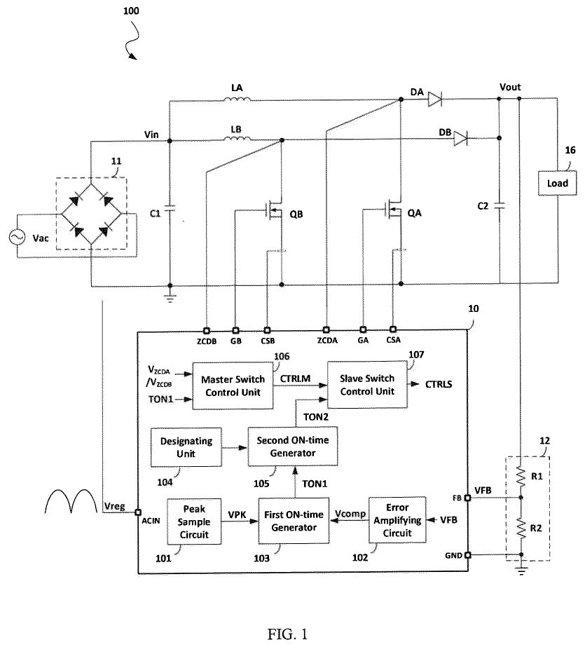

FIG. 1 shows a schematic diagram of an interleaved switching converter 100 in accordance with an embodiment of the present invention. As shown in FIG. 1, the interleaved switching converter 100 comprises a control circuit 10, a rectifier circuit 11, an input capacitor C1, a first switching circuit, a second switching circuit, an output capacitor C2 and a feedback circuit 12.

The rectifier circuit 11 receives an AC voltage Vac, rectifies the AC voltage Vac, and provides an input voltage Vin after being filtered by the input capacitor Cin. In the embodiment shown in FIG. 1, the rectifier circuit 11 may comprise a rectifying bridge consisting of four diodes. In another embodiment, the rectifier circuit 11 may comprise any suitable conventional rectifier circuits, such as a full-bridge rectifier circuit, a half-bridge rectifier circuit, and the like.

As shown in FIG. 1, the first switching circuit comprises a first inductor LA, a first power switch QA, a switch DA, to form a boost power factor correction (PFC) circuit. Similarly, the second switching circuit comprises a second inductor LB, a second power switch QB and a switch DB, to form another boost PFC circuit. The first switching circuit and the second switching circuit are coupled in parallel and are configured to receive the input voltage Vin and to provide an output voltage Vout for providing power to a load.

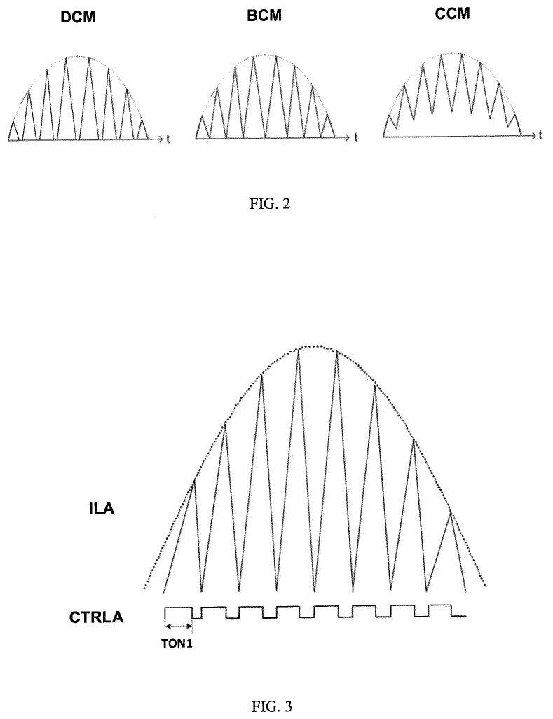

The embodiments of the present invention could be applied to any direct current (“DC”) to DC voltage converters (e.g., buck converters, boost converters, buck-boost converters, flyback converters and/or other type of voltage converters). For ease of description and understanding, in this document, the boost PFC circuit is taken as an example to explain the working principle of the present invention. Generally, the PFC circuit has three working modes: a CCM (Continuous Conduction Mode), a BCM (Boundary Conduction Mode) and a DCM (Discontinuous Conduction Mode). FIG. 2 shows working waveforms of the PFC circuit operating in different working modes.

As shown in FIG. 2, take the first switching circuit as an example, when the first power switch QA is turned on, the input capacitor C1, the first inductor LA and the first power switch QA form a current loop, a current flowing through the first inductor LA increases. When the first power switch QA is turned off, the input capacitor C1, the first inductor LA, the switch DA, the output capacitor C2 and the load form another current loop, the current flowing through the first inductor LA starts to decrease.

The dashed line shown in FIG. 2 indicates that peak envelopes of the current flowing through the first inductor LA in the three working modes, respectively.

Referring still to FIG. 1, the control circuit 10 may be configured as an integrated circuit. The control circuit 10 comprises a peak sample circuit 101, an error amplifying circuit 102, a first ON-time generator 103 and a plurality of terminals.

As used herein, a “terminal” refers to any contact point configured to make an electrical connection. A terminal may be implemented as pin, pad, post, tab, or other conductive feature suitable for electrically coupling to another component or node.

In the embodiment shown in FIG. 1, the plurality of terminals comprises a first current sense terminal CSA, a second current sense terminal CSB, a first zero crossing sense terminal ZCDA, a second zero crossing sense terminal ZCDB, a first control terminal GA, a second control terminal GB, an input sense terminal ACIN, a feedback terminal FB, and a reference ground terminal GND.

In the embodiment shown in FIG. 1, the first current sense terminal CSA is coupled to the first power switch QA, to receive a first current sense signal ILA representative of a current flowing through the first power switch QA. In other embodiments, the first current sense terminal CSA is coupled to the first inductor LA, to provide the first current sense signal ILA by sampling the current flowing through the first inductor LA.

The first zero crossing sense terminal ZCDA is coupled to a common node of the first inductor LA and the first power switch QA, and is configured to receive a first zero crossing detection signal V_{ZCDA} representative of a voltage across the first power switch QA. The second current sense terminal CSB is configured to receive a second current sense signal ILB representative of a current flowing through the second power switch QB. The second zero crossing sense terminal ZCDB is coupled to a common node of the second inductor LB and the second power switch QB, and is configured to receive a second zero crossing detection signal V_{ZCDB} representative of a voltage across the second power switch QB. The first control terminal GA and the second control terminal GB are respectively coupled to a control terminal of the first power switch QA and a control terminal of the second power switch QB.

Referring still to FIG. 1, the feedback terminal FB is coupled to receive a feedback signal VFB representative of the output voltage Vout of the interleaved switching converter 100. In the embodiment shown in FIG. 1, the feedback terminal FB is coupled to the output voltage Vout of the interleaved switching converter 100 through the feedback circuit 12. The feedback circuit 12 comprises a voltage divider and is configured to provide the feedback signal VFB at an output terminal. In the embodiment shown in FIG. 1, the feedback circuit 12 comprises the resistors R1 and R2 coupled in series.

As shown in FIG. 1, the input sense terminal ACIN is coupled to receive an input rectified voltage Vreg. The AC voltage Vac conventionally has as a sine wave, and the input rectified voltage Vreg is a half-sine wave by rectifying the AC voltage Vac, as shown in FIG. 1. In the embodiment shown in FIG. 1, the peak sample circuit 101 receives the input rectified voltage Vreg, to provide a peak signal VPK of the input rectified voltage Vreg by sampling a peak value of the input rectified voltage Vreg. The peak sample circuit 101 may comprise any conventional circuits or methods of sampling the peak of the AC voltage Vac.

The error amplifying circuit 102 is coupled to the feedback terminal FB to receive the feedback signal VFB, and to provide a feedback compensation signal Vcomp based on the feedback signal FB and a reference signal. The reference signal generally indicates an expected output voltage level. In one embodiment, the error amplifying circuit 102 comprises an error amplifier. The inverting input terminal of the error amplifier is configured to receive the feedback signal VFB, the non-inverting input terminal of the error amplifier is configured to receive the reference signal, the output terminal of the error amplifier is configured to provide the feedback compensation signal Vcomp.

The first ON-time generator 103 is configured to provide a first ON-time TON1 based on the feedback compensation signal Vcomp and the peak signal VPK of the input rectified voltage Vreg. In one example, the first ON-time TON1 can be controlled by both the feedback compensation signal Vcomp and the peak signal VPK of the input rectified voltage Vreg, which can be expressed as set forth in equation (1):

$${T}_{O N 1} = {V}_{C O M P} \cdot {K}_{T O N} \cdot \frac{1}{{V}_{P {K}^{2}}} \qquad ( 1 )$$

Where K_{TON} is a proportional coefficient. According to equation (1), the first ON-time TON1 is proportional to the feedback compensation signal Vcomp, and is inversely proportional to the square of the peak signal VPK. When the peak signal VPK of the input rectified voltage Vreg is unchanged, i.e., during the amplitude of the AC voltage Vac is fixed, the first ON-time TON1 is related to the feedback compensation signal Vcomp. The feedback compensation signal Vcomp reflects the load information, and thus the first ON-time TON1 varies with the load.

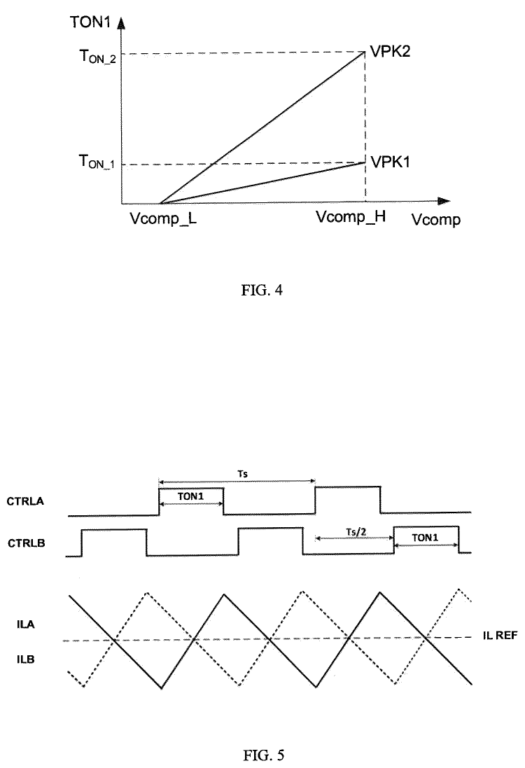

FIG. 4 shows a relationship diagram among a first ON-time, a feedback compensation signal and a peak signal of an input rectified voltage in accordance with an embodiment of the present invention. As shown in FIG. 4, a first peak signal VPK1 is higher than a second peak signal VPK2, and a first feedback compensation signal Vcomp_L is less than a second feedback compensation signal Vcomp_H.

Referring still to FIG. 1, after the control circuit 10 of the interleaved switching converter 100 is powered on, the control circuit 10 is first configured to default one of the first switching circuit and the second switching circuit as a master switching circuit, and to default the other switching circuit as a slave switching circuit.

In an example, the first switching circuit is defaulted as the master switching circuit, the second switching circuit is defaulted as the slave switching circuit. Those skilled in the art will appreciate that embodiments of the present invention described herein is merely one example embodiment of the invention. In other embodiments, the second switching circuit can be defaulted as the master switching circuit, the first switching circuit can be defaulted as the slave switching circuit, depending on the defaulted master-slave configuration of the control circuit 10.

The interleaved switching converter 100 shown in FIG. 1 is controlled by using COT (Constant ON-time) control, and an ON-time of a master switch of the master switching circuit is directly adjusted by loop control. The ON-time of master switch is the first ON-time TON1. In one embodiment, the control circuit 10 further comprises a zero-crossing comparison circuit. The zero-crossing comparison circuit is enabled in BCM, and is configured to compare a zero crossing detection signal of the master switching circuit with a zero crossing threshold voltage, and the master switch is controlled to be turned on based on the comparison. In detail, in one example, in BCM, in each switching cycle of the master switching circuit, when the zero crossing detection signal of the master switching circuit is decreased to the zero crossing threshold voltage, the master switch is turned on. The master switch is turned off when the ON-time of the master switch reaches the first ON-time TON1. The working waveforms of the master switching circuit will be described below with reference to FIG. 3.

FIG. 3 shows working waveforms of a master switching circuit of the interleaved switching converter 100 in accordance with another embodiment of the present invention. In an example shown in FIG. 3, the first switching circuit is defaulted as the master switching circuit, the first power switch QA is the master switch. The first switching circuit operates in BCM with COT control, the ON-time of the master switch is the first ON-time.

As shown in FIG. 3, in a sequence of switching cycles of the master switch, for example, during one AC cycle of the AC voltage Vac, the ON-time of the master switch (the first power switch QA herein) is unchanged and is kept to be the first ON-time TON1.

As shown in FIG. 3, the first power switch QA is coupled to the first control terminal GA of the control circuit 10, to receive a first control signal CTRLA. In detail, in each switching cycle of the first power switch (the master switch). When the first zero crossing detection signal V_{ZCDA} is decreased to the zero crossing threshold voltage, the first power switch QA is turned on, and the first current sense signal ILA starts to increase from zero. When the ON-time of the first power switch QA is increased to the first ON-time TON1, the first power switch QA is turned off, and the current flowing through the first inductor LA starts to decrease. Until the first zero crossing detection signal V_{ZCDA} is decreased to the zero crossing threshold voltage again, the first power switch QA is turned on again, and the above process is repeated continuously. The dotted line shown in FIG. 3 represents the peak envelope of the first current sense signal ILA.

FIG. 5 shows working waveforms of an interleaved switching converter 100 with balanced inductors in accordance with an embodiment of the present invention. As shown in FIG. 5, the first inductor LA of the first switching circuit and the second inductor LB of the second switching circuit are the substantially same and are well balanced. The term “IL REF” represents an average value of the first current sense signal ILA and the second current sense signal ILB.

In the example shown in FIG. 5, the first switching circuit is defaulted as the master switching circuit with the COT control, the second switching circuit is defaulted as the slave switching circuit and substantially follows the operation of the master switching circuit. The first power switch QA is configured to receive the first control signal CTRLA that serves as a master control signal CTRLM, the second power switch QB is configured to receive the second control signal CTRLB that serves as a slave control signal CTRLS.

As shown in FIG. 5, in each switching cycle of the first power switch QA (defaulted as the master switch herein), when the first zero-crossing detection signal V_{ZCDA} decreases to the zero-crossing threshold voltage, the first power switch QA is turned on, and the first current sense signal ILA starts to increase from zero. When the ON-time of the first power switch QA reaches the first ON-time TON1, the first power switch QA is turned off, and the current flowing through the first inductor LA starts to decrease. The master switching circuit is configured to work in BCM, the switching cycle of the first power switch QA is Ts. After the first power switch QA has been turned on for half a switching cycle (0.5*Ts), the second power switch QB (defaulted as the slave switch herein) is turned on, and the second current sense signal ILB starts to increase from zero. When the ON-time of the second power switch QB reaches the first ON-time TON1, the second power switch QB is turned off, and the current flowing through the second inductor LB starts to decrease. The slave switching circuit is also configured to work in BCM. This is a desired situation for the operation of the interleaved switching converter 100 with balanced inductors.

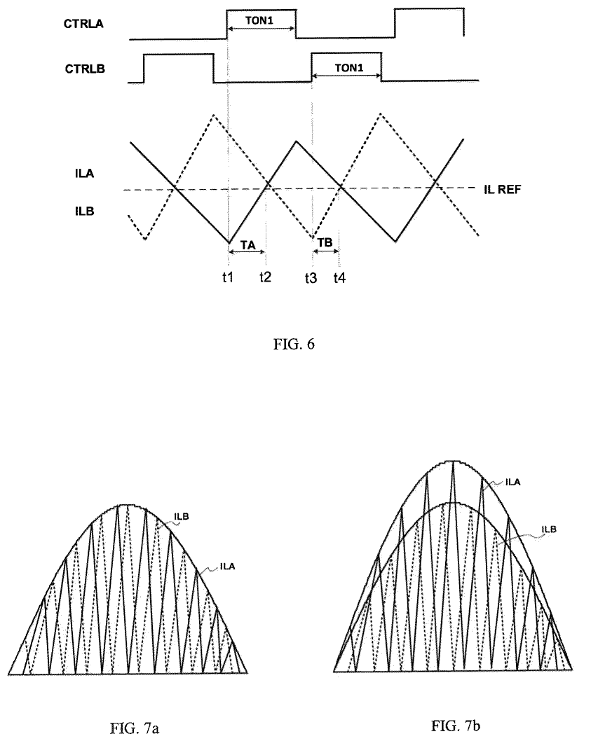

However, in practical applications, the first inductor LA and the second inductor LB are often unbalanced. When the COT control is used in an interleaved switching converter with unbalanced inductors, the working waveforms are shown in FIG. 6.

FIG. 6 shows working waveforms of an interleaved switching converter with unbalanced inductors. In the example shown in FIG. 6, the inductance LA of the first inductor LA is less than the inductance LB of the second inductor LB. The label “IL REF” indicates that the average value of the first current sense signal ILA and the second current sense signal ILB.

In the embodiment shown in FIG. 6, if the first switching circuit defaulted as the master switching circuit adopts the COT control, then the second switching circuit defaulted as the slave switching circuit follows the operation of the master switching circuit. The first control signal CTRLA received by the first power switch QA is a master control signal CTRLM, and the second control signal CTRLB received by the second power switch QB is a slave control signal CTRLS.

As shown in FIG. 6, in each switching cycle of the first power switch QA (the master switch herein), when the first zero-crossing detection signal V_{ZCDA} decreases to the zero-crossing threshold voltage, the first power switch QA is turned on, and the first current sense signal ILA starts to increase from zero. When the ON-time of the first power switch QA reaches the first ON-time TON1, the first power switch QA is turned off, and the current flowing through the first inductor LA starts to decrease. The master switching circuit is still configured to work in BCM. After the first power switch QA has been turned on for half the switching cycle (0.5*Ts), the second power switch QB (the slave switch herein) is turned on, and the second current sense signal ILB starts to increase from zero. When the ON-time of the second power switch QB reaches the first ON-time TON1, the second power switch QB is turned off, and the current flowing through the second inductor LB starts to decrease. In this situation, the slave switching circuit also works in BCM.

However, since the amplitudes of the first current sense signal ILA and the second current sense signal ILB are not equal, this will lead to serious unbalanced heat problems between the first switching circuit and the second switching circuit. For example, the temperature of the first inductor LA is 76°, the temperature of the second inductor LB is 67°, the temperature difference between the two inductors reaches 9°. The temperature of the first power switch QA is 101°, the temperature of the second power switch is 91°, and the temperature difference between the two power switches reaches 10°.

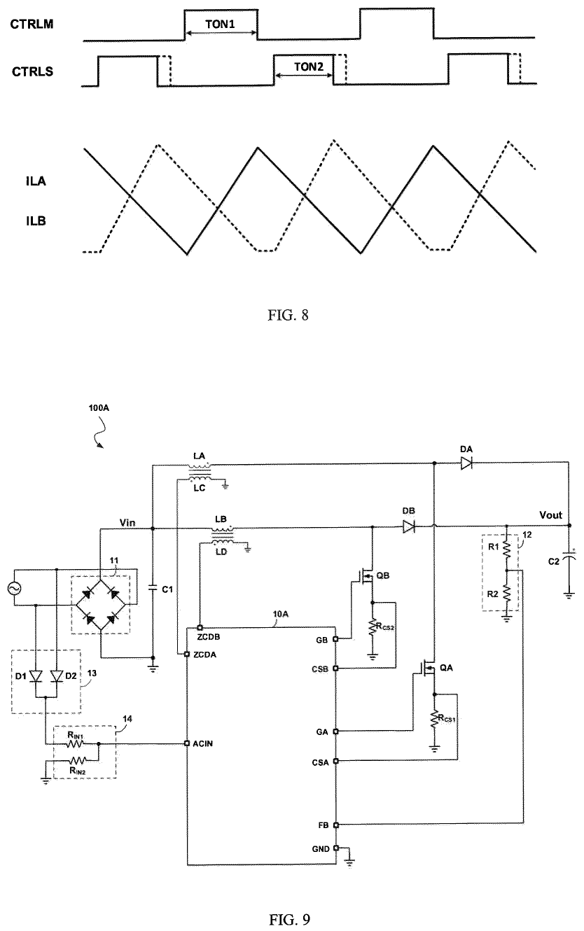

To further show the differences between the working waveforms of the interleaved switching converter with balanced inductors and with unbalanced inductors, FIG. 7a and FIG. 7b are illustrated respectively. FIGS. 7a and 7b show a comparison of working waveforms between the interleaved switching converter with balanced inductors and unbalanced inductors in accordance with an embodiment of the present invention.

As shown in FIG. 7a, when the first inductor LA and the second inductor LB are substantially identical and well balanced, the first switching circuit and the second switching circuit operate alternately, and the first current sense signal ILA and the second current sense signal ILB have the same peak envelopes. However, as shown in FIG. 7b, when the first inductor LA and the second inductor LB are unbalanced, the first switching circuit and the second switching circuit still operate alternately, but the first current sense signal ILA and the second current sense signal ILB have significantly different peak envelopes.

To solve the problems mentioned above, in the embodiment shown in FIG. 1, the control circuit 10 introduces a designating unit 104, the second ON-time generator 105, a master switch control unit 106 and a slave switch control unit 107. The embodiments will be described below with reference to FIG. 1.

Referring still to FIG. 1, the designating unit 104 is configured to selectively and dynamically designate one of the first switching circuit and the second switching circuit as the master switching circuit and the other switching circuit as the slave switching circuit. The power switch of the master switch circuit is the master switch, and the power switch of the slave switching circuit is the slave switch. The designation result of the designating unit 104 may be the same as or different from the defaulted master-slave configuration configured in the control circuit 10. The designated master switching circuit still works in BCM and adopts the COT control, and the ON-time of the master switch is the first ON-time TON1. The main difference is that: after the designating unit 104 performs the master-slave designation, the designated slave switching circuit works in DCM, and the ON-time of the slave switch is the second ON-time TON2, which is shorter than the first ON-time TON1. The second ON-time TON2 is provided by the second ON-time generator 105 based on the first ON-time TON1.

In the embodiment shown in FIG. 1, the master switch control unit 106 provides the main control signal CTRLM for controlling the master switch. The master switching circuit is configured to operate in BCM, and the ON-time of the master switch is the first ON-time TON1. The slave switch control unit 107 provides the slave control signal CTRLS for controlling the slave switch. The slave switching circuit is configured to operate in DCM, and the ON-time of the slave switch is the second ON-time TON2.

Whether the designating unit 104 is enabled to operate depends on whether the first inductor LA and the second inductor LB are unbalanced or mismatched. In one embodiment, if the inductances of the first inductor LA and the second inductor LB are substantially the same, the designating unit 104 will not be enabled. The working waveform of the interleaved switching converter 100 with balanced inductors are shown in FIG. 5, the master-slave relationship between the first switching circuit and the second switching circuit is configured by default, and the ON-time of the master switch is equal to the ON-time of the slave switch, both of which are the first ON-time TON1.

When the imbalance between the first inductor LA and the second inductor LB is detected by the designating unit 104, the designating unit 104 is enabled and designates a suitable switching circuit as the master switching circuit. In one embodiment, the designating unit 104 is configured to designate the first switching circuit as the master switching circuit in response to the peak value of the first current sense signal ILA being less than the peak value of the second current sense signal ILB, that is, to designate the switching circuit with a smaller peak value of the current sense signal as the master switching circuit.

In another embodiment, in response to the inductance L_{A} of the first inductor LA being greater than the inductance L_{B} of the second inductor LB, the designating unit 104 is enabled and designates the first switching circuit as the master switch circuit, that is, to designate the switching circuit with the larger inductance as the master switching circuit. The designated master switching circuit is still configured to operate in BCM, and the ON-time of the master switch is the first ON-time TON1. Meanwhile, the second ON-time generator 105 shown in FIG. 1 provides the second on-time TON2 shorter than the first on-time TON1 based on the first ON-time TON1. The designated slave switching circuit is configured to operate in DCM, and the ON-time of the slave switch is the second ON-time TON2.

In one embodiment, if the inductance L_{B} of the second inductor LB is smaller than the inductance L_{A} of the first inductor LA, the first switching circuit with the larger inductance is designated as the master switching circuit. A relationship between the second ON-time TON2 and the first ON-time TON1 is shown in equation (2):

$${T}_{O N 2} = \sqrt{\frac{{L}_{B}}{{L}_{A}}} {T}_{O N 1} \qquad ( 2 )$$

It can be seen from the equation (2) that, a ratio of the inductance L_{B} of the second inductor LB to the inductance L_{A} of the first inductor LA is equal to the square of the ratio of the second ON-time TON2 to the first ON-time TON1.

In yet another embodiment, the designating unit 104 may designate the master-slave relationship between the first switching circuit and the second switching circuit by detecting a first time duration TA and a second time duration TB, as labelled in FIG. 6. Specifically, the designating unit 104 records the first time duration TA between a first start point (e.g., time t1) at which the first power switch QA is turned on and a first end point (e.g., time t2) at which the first current sense signal ILA increases to a reference current threshold (e.g., IL REF). The designating unit 104 also records the second time duration TB between a second start point (e.g., time t3) at which the second power switch QB is turned on and a second end point (e.g., time t4) at which the second current sense signal ILB increases to the reference current threshold (e.g., IL REF).

In one embodiment, the designating unit 104 designates the first switching circuit as the master switching circuit, in response to the ratio of the first time duration TA to the second time duration TB exceeding a predetermined value. In another embodiment, the ratio between the second time duration TB and the first time duration TA equals to a square of the ratio between the second ON-time TON2 and the first ON-time TON1, and such relationship between the second ON-time TON2 and the first ON-time TON1 can be expressed in equation (3):

$${T}_{O N 2} = \sqrt{\frac{{T}_{B}}{{T}_{A}}} {T}_{O N 1} \qquad ( 3 )$$

FIG. 8 shows working waveforms of an interleaved switching converter 100 after introducing a designating unit 104 according to an embodiment of the present invention.

If the first inductor LA and the second inductor LB are unbalanced, the designating unit 104 performs detection and re-designates the master-slave relationship between the first switching circuit and the second switching circuit.

As shown in FIG. 8, in each switching cycle of the master switch (e.g., the first power switch QA), when the zero-crossing detection signal corresponding to the master switch decreases to the zero-crossing threshold voltage, the master switch is turned on, and the ON-time of the master switch is the first on-time TON1. After the master switch has been turned on for half of the switching cycle (0.5*Ts), the slave switch (e.g., the second power switch QB) is turned on. The ON-time of the slave switch is the second ON-time TON2. The master switching circuit operates in BCM while the slave switching circuit operates in DCM.

In an example, the unbalanced heat problem of the first switching circuit and the second switching circuit is solved. The temperature of the first inductor LA is 72°, the temperature of the second inductor LB is 69°, and the temperature difference between the two inductors is reduced to 3° from 9°. The temperature of the first power switch QA is 96°, the temperature of the second power switch is 95°, and the temperature difference between the two power switches is also reduced to 1° from 10°.

In one embodiment, the control circuit 10 further comprises a storage unit. The first ON-time TON1 is recorded and is stored in the storage unit as the ON-time data of the master switch. In other embodiments, the first ON-time TON1 may also be set by those skilled in the art or users according to application requirements.

FIG. 9 shows a schematic diagram of an interleaved switching converter 100A in accordance with an embodiment of the present invention. Compared with the interleaved switching converter 100 shown in FIG. 1, the interleaved switching converter 100A shown in FIG. 9 further comprises a rectifier circuit 13, a voltage divider circuit 14, current sense resistors Rcs1 and Rcs2, and auxiliary windings LC and LD.

In the embodiment shown in FIG. 9, the rectifier circuit 13 and the voltage divider circuit 14 work together to receive the AC voltage Vac and provide the input rectified voltage Vreg to the input sense terminal ACIN of the control circuit 10A. The rectifier circuit 13 includes two diodes D1 and D2, and the voltage divider circuit 14 includes resistors R_{IN1} and R_{IN2} connected in series, as shown in FIG. 9.

The current sense resistor Rcs1 is connected in series between the first power switch QA and the reference ground terminal GND, to provide the first current sense signal ILA to the first current sense terminal CSA of the control circuit 10A. Similarly, the current sense resistor Rcs2 is connected in series between the second power switch QB and the reference ground terminal GND, to provide the second current sense signal ILB to the second current sense terminal CSB of the control circuit 10A.

As shown in FIG. 9, the auxiliary winding LC is used to detect when the current flowing through the first inductance LA crosses zero. In the embodiment shown in FIG. 9, the first zero crossing sense terminal ZCDA receives the first zero crossing detection signal V_{ZCDA} representing the voltage across the first power switch QA via the auxiliary winding LC. The auxiliary winding LD have the similar functions as the auxiliary winding LC, which is omitted here for clarity.

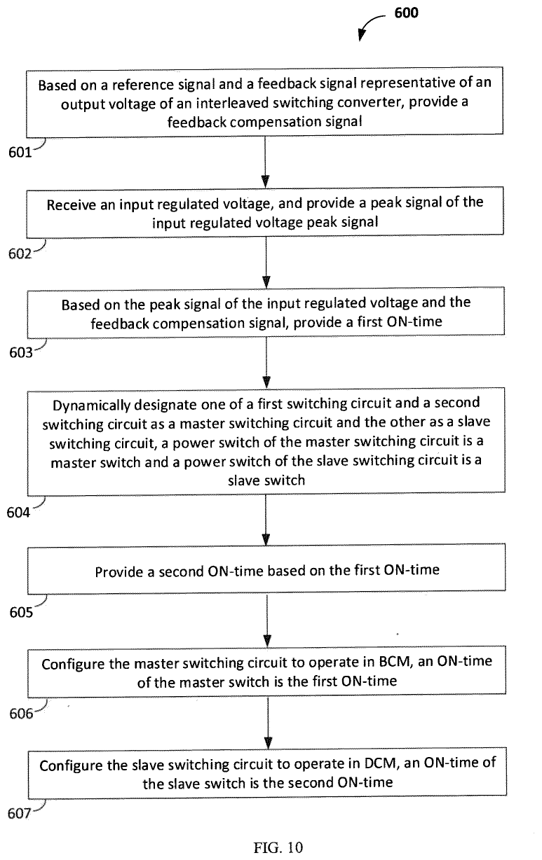

FIG. 10 shows a flow diagram of a control method 600 for an interleaved switching converter in accordance with an embodiment of the present invention. The interleaved switching converter comprises a first switching circuit and a second switching circuit.

In an embodiment, the control method 600 at least comprises steps 604˜607.

At step 604, one of the first switching circuit and the second switching circuit is dynamically designated as a master switching circuit and the other as a slave switching circuit. A power switch of the master switching circuit is configured as a master switch and a power switch of the slave switching circuit is a slave switch.

At step 605, based on a first ON-time, a second ON-time is provided.

At step 606, the master switching circuit is configured to work in BCM, the ON-time of the master switch is the first ON-time.

At step 607, the slave switching circuit is configured to work in DCM, the ON-

time of the slave switch is the second ON-time.

As shown in FIG. 10, the control method 600 may further comprise steps 601˜604 for providing the first ON-time.

At step 601, a feedback compensation signal is provided based on a reference signal and a feedback signal representative of an output voltage of the interleaved switching converter.

At step 602, an input rectified voltage is received and a peak signal of an input rectified voltage is provided.

At step 603, the first ON-time is provided based on the feedback compensation signal and the peak signal of the input rectified voltage. In one embodiment, the first ON-time is proportional to the feedback compensation signal and is inversely proportional to the square of the peak signal of the input rectified voltage.

In one embodiment, a first current sense signal represents a current flowing through a first power switch of the first switching circuit, a second current sense signal represents a current flowing through a second power switch of the second switching circuit. The first switching circuit is designated as the master switching circuit in response to a peak value of the first current sense signal being less than a peak value of the second current sense signal.

In another embodiment, the first switching circuit with a first inductor is designated as the master switching circuit in response to a first inductance of the first inductor being higher than a second inductance of a second inductor of the second switching circuit.

In yet another embodiment, a first time duration from a first start point of turning on the first power switch to a first end point at which the first current sense signal increases to a reference current threshold voltage is recorded. A second time duration from a second start point of turning on the second power switch to a second end point at which the second current sense signal increases to the reference current threshold voltage is recorded. The first switching circuit is designated as the master switching circuit if the first time duration is longer than the second time duration. In one embodiment, the first switching circuit is not designated as the master switching circuit until the ratio between the first time duration and the second time duration exceeds a predetermined value.

In one embodiment of the step 605, the ratio between the second time duration and the first time duration equals to the square of the ratio between the second ON-time and the first ON-time. In another embodiment, the ratio between the second inductance and the first inductance equals to the square of the ratio between the second ON-time and the first ON-time.

In an example, before the step 604, both the first power switch and the second power switch have the same first ON-time, and the first switching circuit and the second switching circuit both operate in BCM with COT control.

The aforementioned control circuit or related control method may be implemented as hardware, or may be implemented as software or firmware executed by a digital controller according to a memory. The digital controller may be used in an integrated control circuit according to the foregoing. Exemplary embodiments may include a computer program product of a computer-readable medium, or computer program code executed by a processor, or the like.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A control circuit for an interleaved switching converter with a first switching circuit and a second switching circuit, the control circuit comprising:
a first current sense terminal configured to receive a first current sense signal representative of a current flowing through a first power switch of the first switching circuit;
a first zero crossing sense terminal configured to receive a first zero crossing detection signal representative of a voltage across the first power switch;
a second current sense terminal configured to receive a second current sense signal representative of a current flowing through a second power switch of the second switching circuit;
a second zero crossing sense terminal configured to receive a second zero crossing detection signal representative of a voltage across the second power switch;
a designating unit configured to selectively designate one of the first switching circuit and the second switching circuit as a master switching circuit and the other as a slave switching circuit;
a master switch control unit configured to control the master switching circuit to operate with a first ON-time;
a second ON-time generator configured to provide a second ON-time based on the first ON-time; and
a slave switch control unit configured to control the slave switching circuit to operate with the second ON-time.

2. The control circuit of claim 1, wherein the designating unit is configured to designate the first switching circuit as the master switching circuit in response to a peak value of the first current sense signal being less than a peak value of the second current sense signal.

3. The control circuit of claim 1, wherein in response to a first inductance of a first inductor of the first switching circuit being greater than a second inductance of a second inductor of the second switching circuit, the designating unit is configured to designate the first switching circuit with the first inductor as the master switching circuit.

4. The control circuit of claim 3, wherein a ratio between the second inductance and the first inductance equals to a square of a ratio between the second ON-time and the first ON-time.

5. The control circuit of claim 1, wherein the designating unit is configured to:
record a first time duration from a first start point of turning on the first power switch to a first end point at which the first current sense signal increases to a reference current threshold voltage;
record a second time duration from a second start point of turning on the second power switch to a second end point at which the second current sense signal increases to the reference current threshold voltage; and
designate the first switching circuit as the master switching circuit if the first time duration is longer than the second time duration.

6. The control circuit of claim 1, wherein the designating unit is configured to:
record a first time duration from a first start point of turning on the first power switch to a first end point at which the first current sense signal increases to a reference current threshold voltage;
record a second time duration from a second start point of turning on the second power switch to a second end point at which the second current sense signal increases to the reference current threshold voltage; and
designate the first switching circuit as the master switching circuit if a ratio between the first time duration and the second time duration exceeds a predetermined value.

7. The control circuit of claim 6, wherein the ratio between the second time duration and the first time duration equals to a square of the ratio between the second ON-time and the first ON-time.

8. The control circuit of claim 1, further comprising:
a feedback terminal configured to receive a feedback signal representative of an output voltage of the interleaved switching converter;
an input sense terminal configured to receive an input rectified voltage;
a peak sample circuit configured to receive the input rectified voltage and to provide a peak signal of the input rectified voltage;
an error amplifying circuit configured to provide a feedback compensation signal based on the feedback signal and a reference signal; and
a first ON-time generator configured to provide the first ON-time based on the feedback compensation signal and the peak signal of the input rectified voltage.

9. The control circuit of claim 8, wherein during a cycle of the input rectified voltage, the first ON-time and the second ON-time are both unchanged, and the second ON-time is shorter than the first ON-time.

10. The control circuit of claim 8, wherein the first ON-time is proportional to the feedback compensation signal and is inversely proportional to a square of the peak signal of the input rectified voltage.

11. The control circuit of claim 1, wherein the master switching circuit is configured to operate in a boundary conduction mode and the slave switching circuit is configured to operate in a discontinuous conduction mode.

12. An interleaved switching converter, comprising:
a first switching circuit having a first inductor and a first power switch;
a second switching circuit having a second inductor and a second power switch;
a control circuit, comprising:
a first current sense terminal configured to receive a first current sense signal representative of a current flowing through the first power switch;
a first zero crossing sense terminal configured to receive a first zero crossing detection signal representative of a voltage across the first power switch;
a second current sense terminal configured to receive a second current sense signal representative of a current flowing through the second power switch;
a second zero crossing sense terminal configured to receive a second zero crossing detection signal representative of a voltage across the second power switch;
a designating unit configured to selectively designate one of the first switching circuit and the second switching circuit as a master switching circuit and the other switching circuit as a slave switching circuit;
a master switch control unit configured to control the master switching circuit to operate with a first ON-time;
a second ON-time generator configured to provide a second ON-time based on a first ON-time; and
a slave switch control unit configured to control the slave switching circuit to operate with the second ON-time.

13. The interleaved switching converter of claim 12, wherein the designating unit is configured to designate the first switching circuit as the master switching circuit in response to a peak value of the first current sense signal being less than a peak value of the second current sense signal.

14. The interleaved switching converter of claim 12, wherein the designating unit is configured to designate the first switching circuit as the master switching circuit in response to a first inductance of the first inductor being higher than a second inductance of the second inductor.

15. The interleaved switching converter of claim 12, wherein the designating unit is configured to:
record a first time duration from a first start point of turning on the first power switch to a first end point at which the first current sense signal increases to a reference current threshold voltage;
record a second time duration from a second start point of turning on the second power switch to a second end point at which the second current sense signal increases to the reference current threshold voltage; and
designate the first switching circuit as the master switching circuit if the first time duration is longer than the second time duration.

16. The interleaved switching converter of claim 12, the control circuit further comprises:
a feedback terminal configured to receive a feedback signal representative of an output voltage of the interleaved switching converter;
an input sense terminal configured to receive an input rectified voltage;
a peak sample circuit configured to receive the input rectified voltage and to provide a peak signal of the input rectified voltage peak;
an error amplifying circuit configured to provide a feedback compensation signal based on the feedback signal and a reference signal; and
a first ON-time generator configured to provide the first ON-time based on the feedback compensation signal and the peak signal of the input rectified voltage.

17. The interleaved switching converter of claim 16, wherein during a cycle of the input rectified voltage, the first ON-time and the second ON-time are both unchanged, and the second ON-time is shorter than the first ON-time.

18. A control method for an interleaved switching converter with a first switching circuit and a second switching circuit, the control method comprising:
dynamically designating one of the first switching circuit and the second switching circuit as a master switching circuit and the other switching circuit as a slave switching circuit;
based on a first ON-time, providing a second ON-time;
configuring the master switching circuit to operate with the first ON-time; and
configuring the slave switching circuit to operate with the second ON-time.

19. The control method of claim 18, wherein designating the first switching circuit as the master switching circuit if a peak value of a first current sense signal is less than a peak value of a second current sense signal, wherein the first current sense signal represents a current flowing through a first power switch of the first switching circuit, and the second current sense signal represents a current flowing through a second power switch of the second switching circuit.

20. The control method of claim 18, wherein designating the first switching circuit as the master switching circuit if a first inductance of a first inductor of the first switching circuit is higher than a second inductance of a second inductor of the second switching circuit.

21. The control method of claim 18, further comprising:
providing a feedback compensation signal based on a reference signal and a feedback signal representative of an output voltage of the interleaved switching converter;
receiving an input rectified voltage and providing a peak signal of an input rectified voltage; and
providing the first ON-time based on the feedback compensation signal and the peak signal of the input rectified voltage.

22. The control method of claim 19, wherein during a cycle of the input rectified voltage, the first ON-time and the second ON-time are both unchanged, and the second ON-time is shorter than the first ON-time.

23. The control method of claim 18, wherein the master switching circuit is configured to operate in a boundary conduction mode and the slave switching circuit is configured to operate in a discontinuous conduction mode.
